(19) United States
(12) Patent Application Publication
(10) Pub. No.: US 2025/0095187 A1
(43) Pub. Date: Mar. 20, 2025

(54) TERMINAL DEVICE, POSITION POSTURE ESTIMATION METHOD, AND PROGRAM

(71) Applicant: SONY GROUP CORPORATION, TOKYO (JP)

(72) Inventors: SHO KAGAMI, TOKYO (JP); JUN GOMITA, TOKYO (JP); MASAYA KANEKO, TOKYO (JP)

(21) Appl. No.: 18/727,510

(22) PCT Filed: Jan. 5, 2023
(86) PCT No.: PCT/JP2023/000051

§ 371 Date: Jul. 9, 2024

(30) Foreign Application Priority Data
Jan. 20, 2022 (JP) 2022-006906

(51) Int. Cl. G06T 7/70; G06F 3/14; G06T 19/00

(52) U.S. Cl. CPC G06T 7/70; G06F 3/14; G06T 19/006

(57) ABSTRACT

The present disclosure relates to a terminal device, a position posture estimation method, and a program that enable environment-independent display of AR content. A position estimation unit estimates an absolute position posture of an own device on the basis of a correspondence between a three-dimensional position included in object data of an object of interest to which a user pays attention and a position, on a camera image of the user, of the object of interest appearing in the camera image. The technology according to the present disclosure is applicable to, for example, an AR device that displays AR content on images of a real space.

### TECHNICAL FIELD

The present disclosure relates to a terminal device, a position posture estimation method, and a program, and more particularly, to a terminal device, a position posture estimation method, and a program that enable environment-independent display of AR content.

### BACKGROUND ART

For sports broadcasting, there is a technology to superimpose, as augmented reality (AR) content, a line representing a world record or information called a ghost modeled after a past player or the like on images and broadcast the resultant images. This technology allows a viewer to feel a tense atmosphere more or obtain additional information, so that the technology is essential for modern sports broadcasting.

While viewers viewing sports broadcasting on a television receiver or the like can view such AR content, spectators actually in a stadium cannot view such AR content. Such spectators, therefore, used not to be able to enjoy images on which AR content is superimposed.

On the other hand, a technology to enable a spectator in a stadium to superimpose AR content on real images through an imaging device such as AR glasses has been proposed. For example, Patent Document 1 discloses a technology to superimpose content based on the position of a competitor, such as an offside line in soccer, on images captured by an imaging unit of a terminal device carried by a spectator. This technology can be enabled by acquiring a self-position posture of a spectator using a pitch (field) line of a soccer stadium or the like as a marker.

### CITATION LIST

### Patent Document

Patent Document 1: WO 2016/017121 A

### SUMMARY OF THE INVENTION

### Problems to be Solved by the Invention

The technology disclosed in Patent Document 1, however, requires the imaging unit to capture an image of a special marker provided in the stadium. The technology disclosed in Patent Document 1, therefore, is not applicable to a stadium having no object that can serve as a marker, or it is costly to newly install a marker.

The present disclosure has been made in view of such circumstances, and it is therefore an object of the present disclosure to enable environment-independent display of AR content.

### Solutions to Problems

A terminal device of the present disclosure includes a position estimation unit configured to estimate an absolute position posture of an own device on the basis of a correspondence between a three-dimensional position included in object data of an object of interest to which a user pays attention and a position, on a camera image of the user, of the object of interest appearing in the camera image.

A position posture estimation method of the present disclosure includes, by a terminal device, estimating an absolute position posture of an own device on the basis of a correspondence between a three-dimensional position included in object data of an object of interest to which a user pays attention and a position, on a camera image of the user, of the object of interest appearing in the camera image.

A program of the present disclosure causes a computer to perform processing, the processing including estimating an absolute position posture of a terminal device on the basis of a correspondence between a three-dimensional position included in object data of an object of interest to which a user pays attention and a position, on a camera image of the user, of the object of interest appearing in the camera image.

In the present disclosure, the absolute position posture of the terminal device is estimated on the basis of the correspondence between the three-dimensional position included in the object data of the object of interest to which the user pays attention and the position, on the camera image of the user, of the object of interest appearing in the camera image.

### BRIEF DESCRIPTION OF DRAWINGS

FIG. 1 is a diagram for describing an overview of the technology according to the present disclosure.

FIG. 2 is a diagram illustrating a configuration example of an AR display system to which the technology according to the present disclosure is applied.

FIG. 3 is a block diagram illustrating a functional configuration example of a server.

FIG. 4 is a diagram for describing a self-position posture acquisition method.

FIG. 5 is a diagram illustrating an overview of Visual SLAM.

FIG. 6 is a diagram for describing a tracking technique.

FIG. 7 is a flowchart for describing a flow of operation of the server.

FIG. 8 is a block diagram illustrating a functional configuration example of a terminal device.

FIG. 9 is a diagram illustrating how an absolute position posture is estimated on the basis of a three-dimensional position and a camera image.

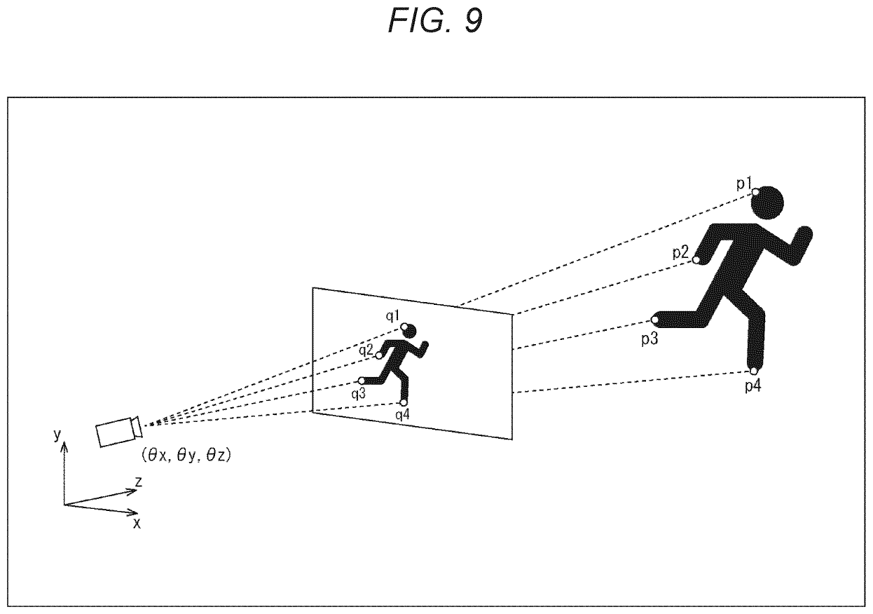

FIG. 10 is a flowchart for describing a flow of operation of the terminal device.

FIG. 11 is a block diagram illustrating another functional configuration example of the terminal device.

FIG. 12 is a flowchart for describing a flow of operation of the terminal device.

FIG. 13 is a block diagram illustrating a configuration example of a computer.

### MODE FOR CARRYING OUT THE INVENTION

Hereinafter, modes for carrying out the present disclosure (hereinafter referred to as embodiments) will be described. Note that the description will be given in the following order.
1. Overview of technology according to the present disclosure
2. Configuration example of AR display system
3. Configuration and operation of server
4. Configuration and operation of terminal device
5. Modification
6. Configuration example of computer

### 1. Overview of Technology According to Present Disclosure

For sports broadcasting, there is a technology to superimpose, as augmented reality (AR) content, a line representing a world record or information called a ghost modeled after a past player or the like on images and broadcast the resultant images. This technology allows a viewer to feel a tense atmosphere more or obtain additional information, so that the technology is essential for modern sports broadcasting.

While viewers viewing sports broadcasting on a television receiver or the like can view such AR content, spectators actually in a stadium cannot view such AR content. Such spectators, therefore, used not to be able to enjoy images on which AR content is superimposed.

The present disclosure, therefore, proposes a technology in which spectators in a stadium superimposes AR content on real images through an imaging device such as AR glasses.

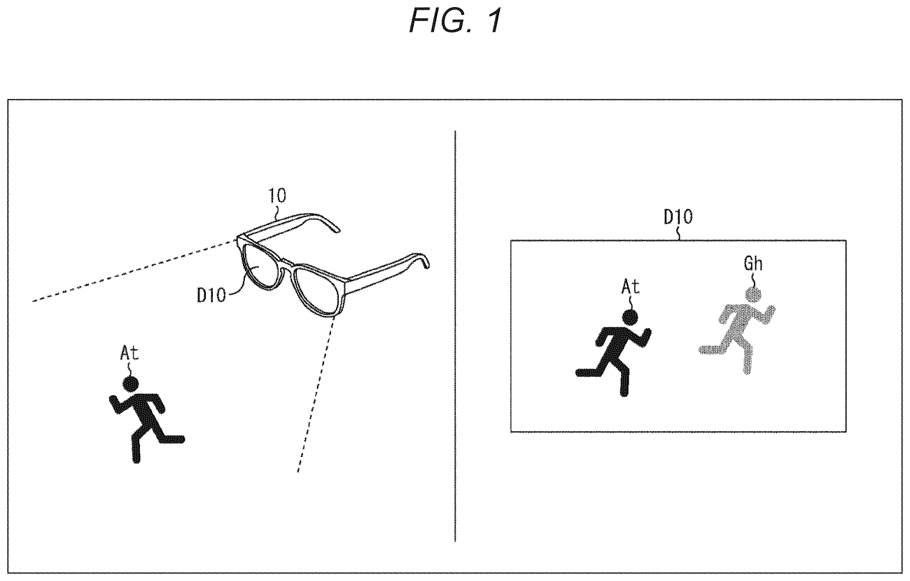

For example, as illustrated on the left side of FIG. 1, it is assumed that a spectator (user) in a stadium pays attention to a competitor At with the spectator wearing AR glasses 10. The AR glasses 10 are configured as optical see-through AR glasses, and the user can view the competitor At through a display D10 of a lens portion.

Furthermore, as illustrated on the right side of FIG. 1, a ghost Gh as AR content is displayed at a display position corresponding to the competitor At on the display D10 as viewed from the user. In the example illustrated in FIG. 1, the ghost Gh is, for example, information modeled after a world record holder in a competition in which the competitor At is participating. The AR content is not limited to three-dimensional stereoscopic image information such as the ghost Gh, and may be various display information such as two-dimensional image information, any geometric graphics information, or character information.

As described above, the technology according to the present disclosure enables not only viewers viewing sports broadcasting on television receivers or the like but also spectators actually in a stadium to enjoy AR content. In particular, the technology according to the present disclosure enables display of such AR content without a camera provided in the AR glasses capturing an image of a special marker or the like provided in the stadium.

### 2. Configuration Example of AR Display System

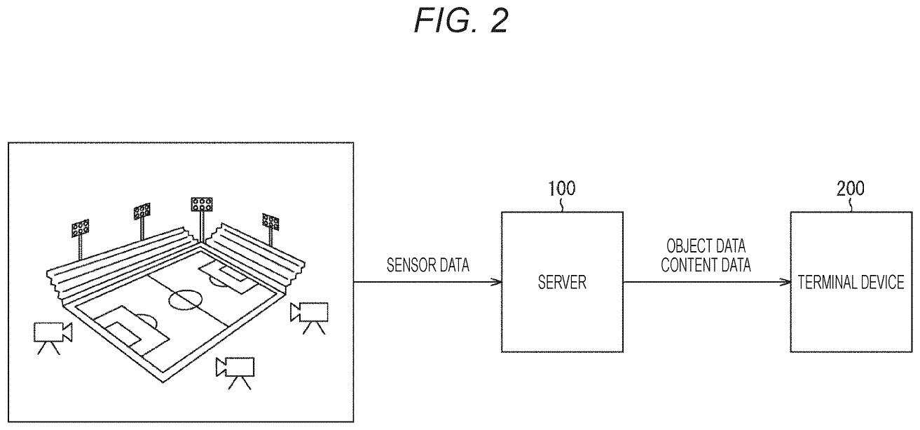

FIG. 2 is a diagram illustrating a configuration example of an AR display system to which the technology according to the present disclosure is applied.

The AR display system illustrated in FIG. 2 includes a server 100 and a terminal device 200.

The server 100 includes, for example, a cloud server provided outside a stadium. The server 100 acquires sensor data from a large number of cameras installed around a stadium, sensors such as a broadcast camera handled by a camera crew, a sensor worn by a competitor, and the like.

The server 100 generates object data regarding an object such as a competitor participating in a sports competition held in the stadium on the basis of the acquired sensor data, and distributes the object data to the terminal device 200. Although the following description will be given on the assumption that the object is a human who is a competitor, the object may be any object related to sports competition, and examples of the object include an animal such as a horse, a machine (vehicle) such as an automobile or a bicycle, and equipment such as a ball. Furthermore, the object may be each joint of a competitor (human) or an animal, or a part of a machine or equipment.

Furthermore, the server 100 generates content data used to display AR content corresponding to each object on the terminal device 200, and distributes the content data to the terminal device 200.

The terminal device 200 includes an AR device such as AR glasses described with reference to FIG. 1 or a smartphone. The terminal device 200 may include binoculars similar in functionality to the AR glasses and configured to magnify the field of view at a predetermined magnification. The terminal device 200 displays, on the basis of the object data and the content data from the server 100, the AR content at a display position, on a display area of the terminal device 200, corresponding to an object to which the user pays attention (hereinafter, referred to as object of interest).

Specifically, in a case where the terminal device 200 includes AR glasses, the AR content is displayed at the display position corresponding to the object of interest in a display area serving as a display of a lens portion and transmitting a real space including the object of interest. Furthermore, in a case where the terminal device 200 includes a smartphone, the AR content is superimposed and displayed at the display position corresponding to the object of interest on a camera image including the object of interest displayed in a display area serving as a display of the smartphone.

Hereinafter, functions and operations of the server 100 and the terminal device 200 will be described in detail.

### 3. Configuration and Operation of Server

### Functional Configuration Example of Server

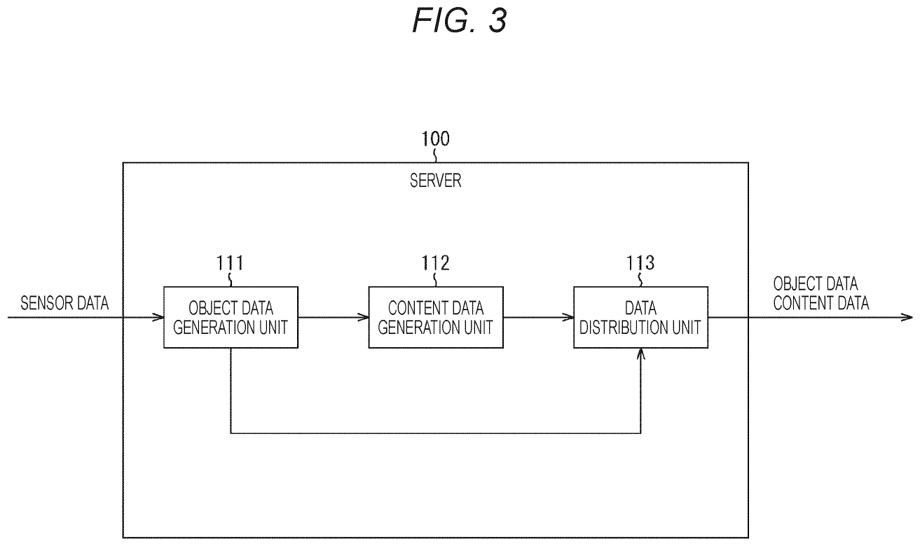

FIG. 3 is a block diagram illustrating a functional configuration example of the server 100 constituting a part of the AR display system in FIG. 2.

As illustrated in FIG. 3, the server 100 includes an object data generation unit 111, a content data generation unit 112, and a data distribution unit 113.

The object data generation unit 111 generates object data regarding an object on the basis of sensor data acquired from a large number of cameras installed around a stadium, sensors such as a broadcast camera handled by a camera crew, a sensor worn by a competitor, and the like.

The object data includes three-dimensional position information indicating a three-dimensional position (x, y, z) of the object. Examples of the method for generating the three-dimensional position information include the following methods.

### (1) Method Using Sensor Data Acquired From a Large Number of Cameras Installed Around a Stadium

In a case where the sensor data is acquired from the large number of cameras installed around the stadium, the object data generation unit 111 generates three-dimensional positional information regarding each object by converting images captured by each camera into three-dimensional data.

### (2) Method Using Sensor Data Acquired From Sensors Such as Broadcast Camera

In a case where the sensor data is acquired from the sensors such as the broadcast camera handled by the camera crew, the object data generation unit 111 acquires a self-position posture of the broadcast camera and tracks the object with the broadcast camera, so as to generate three-dimensional position information regarding each object.

Examples of the method for acquiring the self-position posture of the broadcast camera include an Outside-In method and an Inside-Out method.

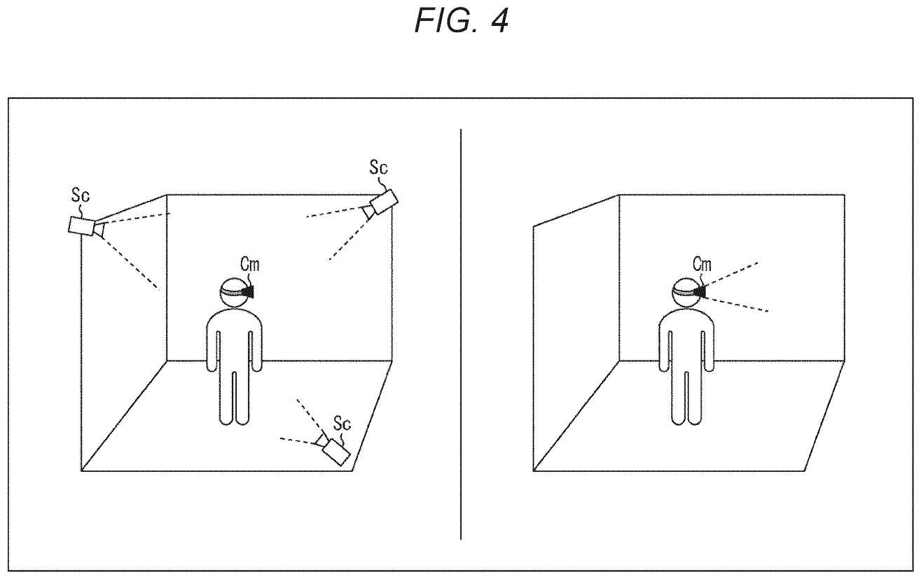

As illustrated on the left side of FIG. 4, the Outside-In method is a method for acquiring a self-position posture of a camera Cm to which a marker is attached and recognizing the marker with a plurality of sensors Sc installed in the stadium.

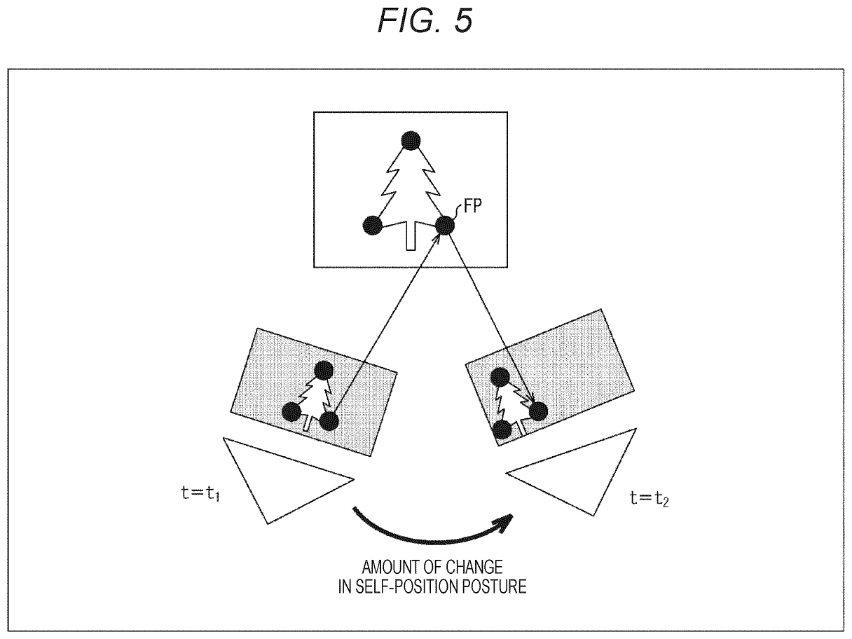

As illustrated on the right side of FIG. 4, the Inside-Out method is a method for acquiring the self-position posture of the camera Cm by the camera Cm itself observing an external environment. In the Inside-Out method, visual simultaneous localization and mapping (SLAM) is used. As illustrated in FIG. 5, the Visual SLAM is a technique to estimate an amount of change in self-position posture between time t₁ and time t₂ by calculating a distance between a feature point FP on an image acquired at the time t₁ and a feature point FP on an image acquired at the time t₂.

After acquiring the self-position posture of the broadcast camera as described above, the object data generation unit 111 acquires the three-dimensional position of the object using a combination of a tracking technique and a depth estimation technique.

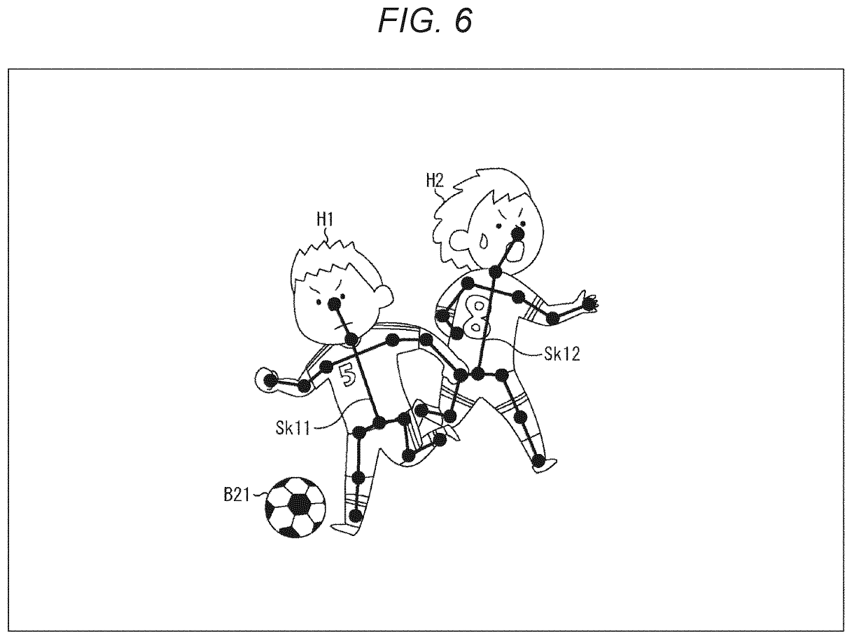

First, the tracking technique uses a technique to track a person or an object using machine learning or the like. In order to estimate an absolute position posture using an object, it is required that a plurality of suitable objects be present. In a case where the number of objects is smaller than the required minimum number, for example, as illustrated in FIG. 6, a pose of a skeletal frame of each competitor serving as an object is estimated, and each skeletal frame is used as an object. Accordingly, a position, on a broadcast camera image, of the competitor himself/herself or each joint of the competitor on images captured by the broadcast camera is acquired. In the example illustrated in FIG. 6, a pose of a skeletal frame Sk 11 of a competitor H1 and a pose of a skeletal frame Sk 12 of a competitor H2 are estimated. In the example illustrated in FIG. 6, a ball B21 may be an object being tracked. Next, a three-dimensional position of each joint in a camera coordinate system of the broadcast camera is acquired by the depth estimation technique. Thereafter, an absolute three-dimensional position of each joint in the stadium is acquired by using the self-position posture of the broadcast camera.

For the depth estimation, a single camera may be used, or a ranging sensor such as light detection and ranging (LiDAR), a direct time of flight (dToF) sensor, or an indirect time of flight (iToF) sensor may be used. Furthermore, an event camera that detects a change in luminance as an event may be used to track the object. The event camera enables tracking of an object moving at high speed.

### (3) Method Using Sensor Data Acquired From Sensor Worn by Competitor

In a case where the sensor data is acquired from the sensor worn by the competitor, the object data generation unit 111 generates the three-dimensional position information regarding each object using the self-position posture acquisition method based on the Outside-In method or the Inside-Out method described above.

Among the above-described methods for generating three-dimensional position information, (1) can be implemented by an existing system, and can be applied to some competitions such as soccer and rugby, for example. On the other hand, (2) and (3) can also be applied to competitions held in a vast stadium such as a horse race and a car race to which it is difficult to apply (1), or competitions such as skiing, snowboarding, a marathon, and a road race for which it is difficult to install a camera.

The three-dimensional position information generated as described above includes not only the three-dimensional position of the object but also the three-dimensional position of each joint or each part constituting the object.

The object data may further include a feature of the object in addition to the three-dimensional position information regarding the object.

Such an object feature may be an ID assigned to each object that is identified during tracking, a multi-dimensional feature vector, image data of the object, three-dimensional data of the object appearing in the images generated for broadcasting, or the like. Note that the feature of the object can be extracted from the images in a case where the above-described method for generating three-dimensional position information is either (1) or (2), both using a camera.

Furthermore, the object data may further include an acquisition time of the sensor data used to generate the three-dimensional position information regarding each object.

The object data generated as described above is supplied to the content data generation unit 112 and the data distribution unit 113.

The content data generation unit 112 generates content data of AR content to be displayed at the display position corresponding to each object on the terminal device 200 on the basis of the object data from the object data generation unit 111.

The content data generation unit 112 generates competition-specific AR content. The AR content is display information representing a record of a sports competition, reproduction of a motion of the object of interest, and a trajectory of the object of interest. For example, in a case of soccer, a ghost representing the replay of a competitor, an image representing an offside line, an effect image representing the trajectory of a ball, or the like is generated as AR content. Furthermore, in a case of track and field, swimming, snowboarding, ski jumping, or the like, an image representing a world record line, a ghost modeled after a world record holder, a ghost representing the replay of a competitor, or the like is generated as AR content. Moreover, in a case of a car race or a road race, an image representing a world record line, a ghost modeled after a world record holder, a ghost representing the replay of a competing vehicle, an effect image representing the trajectory of a vehicle body, or the like is generated as AR content.

The content data generation unit 112 may generate AR content specific to the user of the terminal device 200 or may generate AR content as a preparation to broadcasting.

The content data generated as described above is supplied to the data distribution unit 113.

The data distribution unit 113 distributes the object data supplied from the object data generation unit 111 and the content data supplied from the content data generation unit 112 to the terminal device 200.

### Operation of Server

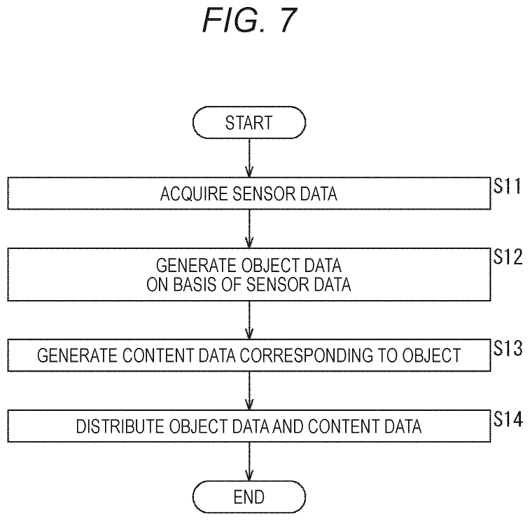

A flow of operation (processing) of the server 100 will be described with reference to the flowchart in FIG. 7. The processing illustrated in FIG. 7 is repeatedly performed in synchronization with, for example, a frame rate at which the AR content is displayed on the terminal device 200.

In step S11, the object data generation unit 111 acquires sensor data from various sensors installed in the stadium.

In step S12, the object data generation unit 111 generates object data of each object present in the stadium on the basis of the acquired sensor data. In step S13, the content data generation unit 112 generates content data corresponding to each object present in the stadium.

In step S14, the data distribution unit 113 distributes the object data generated by the object data generation unit 111 and the content data generated by the content data generation unit 112 to the terminal device 200.

### 4. Configuration and Operation of Terminal Device

### Functional Configuration Example of Terminal Device

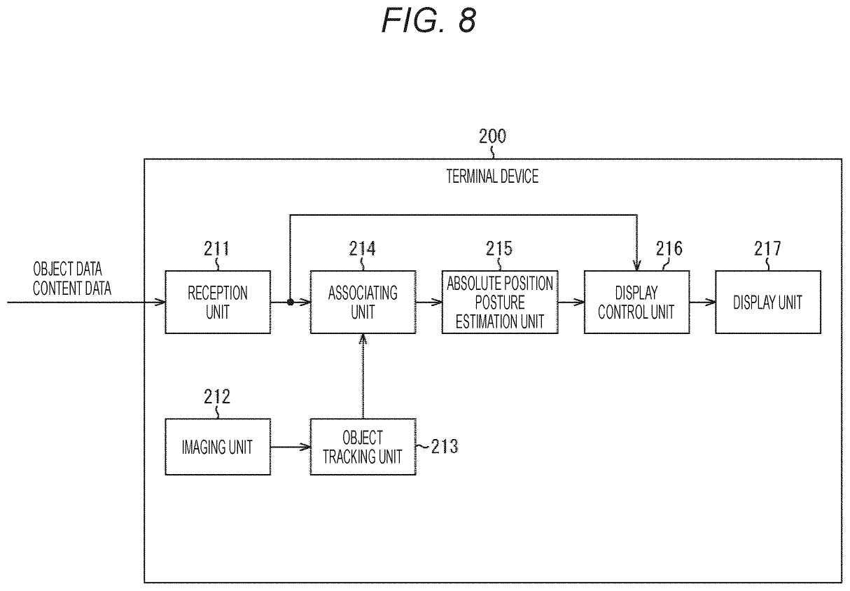

FIG. 8 is a block diagram illustrating a functional configuration example of the terminal device 200 constituting a part of the AR display system in FIG. 2.

As illustrated in FIG. 8, the terminal device 200 includes a reception unit 211, an imaging unit 212, an object tracking unit 213, an associating unit 214, an absolute position posture estimation unit 215, a display control unit 216, and a display unit 217.

The reception unit 211 receives the object data and the content data distributed from the server 100. The object data is supplied to the associating unit 214, and the content data is supplied to the display control unit 216.

The imaging unit 212 is configured as a camera mounted or built in the terminal device 200, and outputs a camera image obtained by capturing an image of a range covering the viewpoint of the user. That is, the camera image can be referred to as moving image adapted to the viewpoint of the user, and some or all of the objects appearing in the camera image can be referred to as object of interest to which the user pays attention. The camera image output by the imaging unit 212 is supplied to the object tracking unit 213.

The object tracking unit 213 tracks an object (object of interest) appearing in the camera image supplied from the imaging unit 212. The object tracking unit 213 may use different tracking techniques in a manner that depends on whether the object is a human, an animal, or a machine.

For example, in a case where the object is a competitor (human), as described with reference to FIG. 6, the position of each joint of the competitor may be set as the object being tracked. It is therefore possible to obtain, for example, even in a case where there are few competitors, the number of corresponding objects necessary for the absolute position posture estimation. In a case where the object is an automobile or a bicycle, for example, the position of a tire (wheel) can be used as the object being tracked. Machine learning is used to track such an object, and it is possible to perform tracking with high robustness by tuning a machine learning model in accordance with the object being tracked.

The position, on the camera image, of the object of interest appearing in the camera image is supplied to the associating unit 214.

The associating unit 214 associates the three-dimensional position represented by the three-dimensional position information included in the object data of the object of interest supplied from the server 100 with the position, on the camera image, of the object of interest appearing in the camera image supplied from the object tracking unit 213.

The method for associating the three-dimensional position of the object of interest with the position, on the camera image, of the object of interest appearing in the camera image differs in a manner that depends on the method for generating the three-dimensional position information regarding each object in the server 100.

In a case where the method for generating the three-dimensional position information regarding each object in the server 100 is either (1) or (2), both using a camera, the three-dimensional position of the object of interest and the position on the camera image are associated with each other on the basis of the feature of the object of interest included in the object data and the feature of the object of interest appearing in the camera image. Specifically, by matching the feature of the object of interest included in the object data with the feature of the object of interest appearing in the camera image, the object of interest present in the real space and the object of interest appearing in the camera image are uniquely associated with each other. Note that the feature may include information specific to a competitor, such as a number cloth or a number plate of the competitor.

The recent development in machine learning has increased the level of personal authentication technology. With such a personal authentication technology, the feature of each competitor is calculated and compared with the feature acquired from the camera image, and in a case where the features are sufficiently close to each other, the competitor is associated with the features. Such features may be learned from many photographs prepared for each competitor in advance, or may be learned online by means of unsupervised learning.

For the associated object of interest, the three-dimensional position of each joint or each part constituting the object of interest and the position, on the camera image, of each joint and each part of the object of interest appearing in the camera image can be further associated with each other.

In a case where the method for generating the three-dimensional position information regarding each object in the server 100 is (3) method using a sensor attached to an object, the sensor attached to the object of interest (used in the Outside-In method described above) appearing in the camera image is recognized, so that the three-dimensional position of the object of interest is obtained and associated with the position on the camera image.

For example, the association of the object of interest described above is necessary for a competition with a plurality of competitors, but is unnecessary for a competition with only one competitor such as figure skating because the object of interest can be uniquely identified. For a competition with a plurality of competitors, the three-dimensional position of each competitor and the position on the camera image may be associated with each other on the basis of the relative position of each competitor.

A correspondence between the three-dimensional position of the associated object of interest and the position on the camera image is supplied to the absolute position posture estimation unit 215.

The absolute position posture estimation unit 215 estimates the absolute position posture of the own device (terminal device 200) on the basis of the correspondence between the three-dimensional position of the object of interest and the position, on the camera image, of the object of interest appearing in the camera image. The absolute position posture estimation unit 215 estimates, as the absolute position posture of the terminal device 200, variables of six degrees of freedom of the three-dimensional position (x, y, z) and posture (θx, θy, θz) of the terminal device 200.

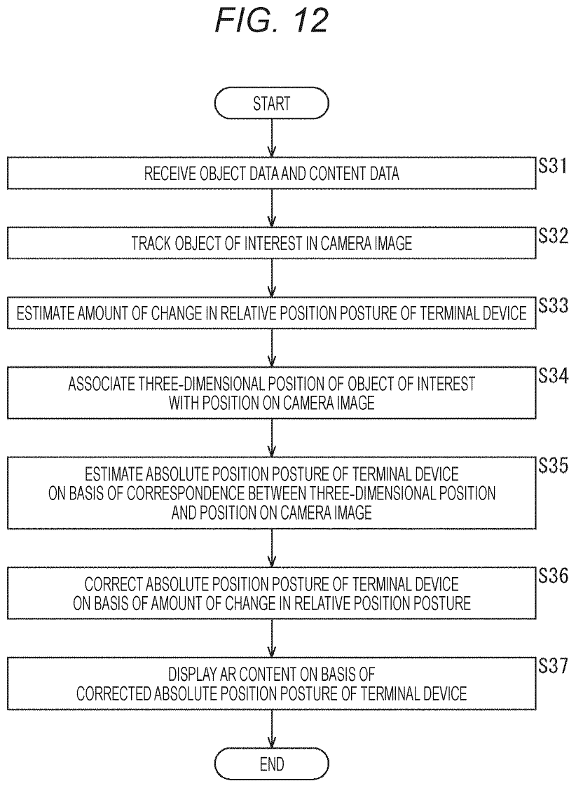

For example, as illustrated in FIG. 12, such variables can be obtained in a case where the correspondence between the three-dimensional position (x, y, z) of each point p1, p2, p3, or p4 of the object of interest and the position (u, v), on the camera image, of each point q1, q2, q3, or q4 of the object of interest appearing in the camera image is known.

The estimated absolute position posture of the terminal device 200 is supplied to the display control unit 216.

The display control unit 216 controls, on the basis of the absolute position posture of the terminal device 200 estimated by the absolute position posture estimation unit 215, display of the AR content represented by the content data at the display position on the display area of the display unit 217 corresponding to the object of interest. Specifically, the display control unit 216 determines the display position of the AR content in the display area of the display unit 217 on the basis of the absolute position posture of the terminal device 200, and renders, at the determined display position, the AR content based on the content data.

In a case where the terminal device 200 includes AR glasses, the display unit 217 is configured as a display of a lens portion. The display control unit 216 displays, in the display area that transmits the real space including the object of interest, the AR content at the display position on the display area corresponding to the object of interest.

In a case where the terminal device 200 includes a smartphone, the display unit 217 is configured as a display of a smartphone. The display control unit 216 superimposes, on the camera image including the object of interest displayed in the display area of the display, the AR content at the display position on the display area corresponding to the object of interest and displays the resultant image.

### Operation of Terminal Device

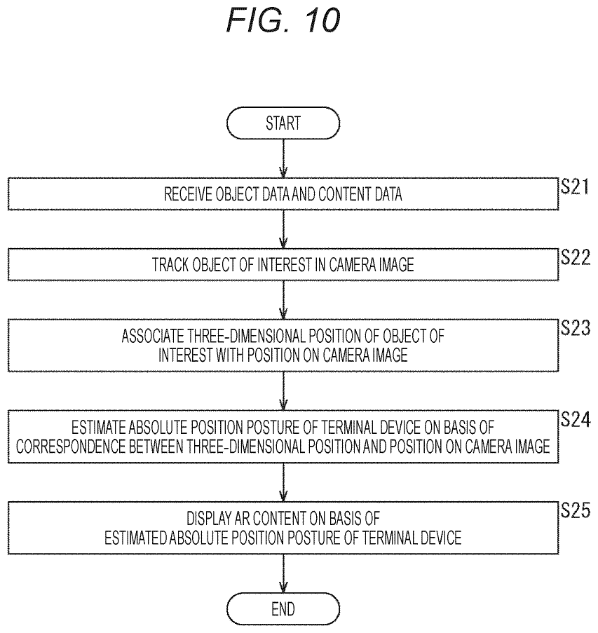

A flow of operation (processing) of the terminal device 200 will be described with reference to the flowchart in FIG. 10. The processing illustrated in FIG. 10 is repeatedly performed in synchronization with, for example, a frame rate at which the AR content is displayed on the display unit 217.

In step S21, the reception unit 211 receives the object data and the content data distributed from the server 100.

In step S22, the object tracking unit 213 tracks the object of interest appearing in the camera image captured by the imaging unit 212.

In step S23, the associating unit 214 associates the three-dimensional position represented by the three-dimensional position information included in the object data of the object of interest with the position, on the camera image, of the object of interest tracked in the camera image.

In step S24, the absolute position posture estimation unit 215 estimates the absolute position posture of the terminal device 200 on the basis of the correspondence between the three-dimensional position of the object of interest and the position, on the camera image, of the object of interest appearing in the camera image.

In step S25, the display control unit 216 displays, on the basis of the absolute position posture of the terminal device 200 estimated by the absolute position posture estimation unit 215, the AR content represented by the content data at the display position, on the display area of the display unit 217, corresponding to the object of interest.

According to the above-described configuration and processing, the self-position posture of the user can be estimated on the basis of the correspondence between the three-dimensional position of the object of interest to which the user pays attention and the position, on the camera image, of the object of interest appearing in the camera image. In other words, the self-position posture of the user can be estimated using the object of interest as a marker. Therefore, the technology according to the present disclosure is also applicable to a stadium where there is nothing that can be a marker, and enables environment-independent display of AR content without cost of installing a new marker.

### 5. Modification

### Delay Time

In the AR display system described above, it is assumed that a time difference (delay time) from the acquisition of the sensor data to the display of the AR content is extremely small. Therefore, data transmission and reception through high-speed communication such as 5th generation mobile communication system (5G) is required between the sensor and the server 100 and between the server 100 and the terminal device 200. Furthermore, it is desirable for the server 100 to make the time taken to generate the AR content as short as possible by, for example, using past AR content or generating AR content in advance.

On the other hand, in the AR display system described above, in a case where the delay time from the acquisition of the sensor data to the display of the AR content is large, the position of the user or the object changes during the delay time, and there is a possibility that the display position of the AR content relative to the object of interest deviates from the intended display position.

Therefore, a configuration for enabling display of AR content with the delay time from the acquisition of the sensor data to the display of the AR content compensated for will be described below.

### Functional Configuration Example of Terminal Device

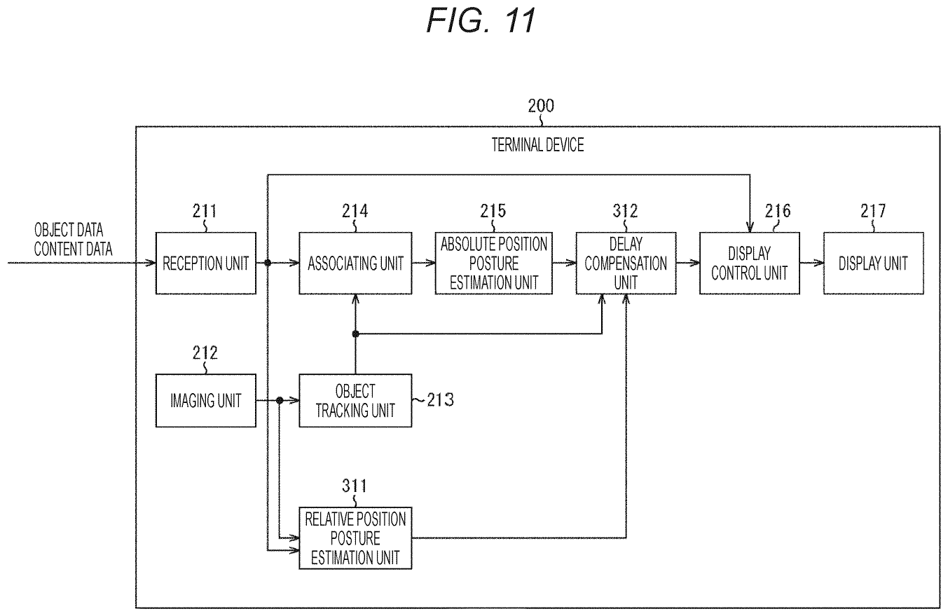

FIG. 11 is a block diagram illustrating a functional configuration example of a terminal device 200 capable of compensating for the delay time from the acquisition of the sensor data to the display of the AR content.

Of the terminal device 200 illustrated in FIG. 11, functional blocks similar in functionality to the functional blocks of the terminal device 200 illustrated in FIG. 8 are denoted by the same reference numerals, and the description of the functional blocks will be omitted as appropriate.

The terminal device 200 illustrated in FIG. 11 is different from the terminal device 200 illustrated in FIG. 8 in that a relative position posture estimation unit 311 and a delay compensation unit 312 are additionally provided.

The relative position posture estimation unit 311 estimates, on the basis of the camera image from the imaging unit 212, an amount of change in relative position posture of the own device (terminal device 200) from the acquisition time included in the object data of the object of interest by Visual SLAM described with reference to FIG. 5. The relative position posture estimation unit 311 is configured to hold an amount of past change in relative position posture of the terminal device 200.

Note that, in addition to Visual SLAM, one of or a combination of ranging sensors such as an inertial measurement unit (IMU), a LiDAR, a dToF sensor, and an iToF sensor may be used in estimation of the amount of change in relative position posture of the terminal device 200.

The estimated amount of change in relative position posture of the terminal device 200 is supplied to the delay compensation unit 312.

Meanwhile, in the object tracking unit 213, the camera image from the imaging unit 212 advances by the delay time from the acquisition of the sensor data to the reception of the content data. Therefore, the object tracking unit 213 is configured to hold a position (trajectory), on a past camera image, of the object of interest appearing in the camera image. The position of the object of interest on the camera image captured a delay time ago is supplied to the associating unit 214.

Furthermore, the three-dimensional position and the posture of the terminal device 200 estimated by the absolute position posture estimation unit 215 are a three-dimensional position and a posture at the time when the server 100 acquires the sensor data for the object of interest, and the three-dimensional position and posture deviate from the actual three-dimensional position posture.

Therefore, the delay compensation unit 312 corrects the absolute position posture of the terminal device 200 estimated by the absolute position posture estimation unit 215 in accordance with the acquisition time included in the object data of the object of interest. Specifically, the delay compensation unit 312 corrects the absolute position posture of the terminal device 200 on the basis of the amount of change in relative position posture of the terminal device 200 estimated by the relative position posture estimation unit 311.

Furthermore, the delay compensation unit 312 also corrects the position of the object of interest in addition to the correction of the absolute position posture of the terminal device 200. This is because there is a possibility that the object of interest moves between the time when the sensor data is acquired and the time when the absolute position posture is estimated. Therefore, the delay compensation unit 312 acquires the position on the camera image by projecting the object of interest onto the absolute position posture corrected in accordance with the acquisition time. In a case where this position deviates from the position of the object of interest on the camera image at the time when the absolute position posture is estimated, it indicates that the object of interest has moved. In this case, the delay compensation unit 312 corrects the three-dimensional position of the object of interest by predicting the three-dimensional position using the amount of change in the position on the camera image.

The absolute position posture of the terminal device 200 and the three-dimensional position of the object of interest thus corrected are supplied to the display control unit 216.

The display control unit 216 controls, on the basis of the absolute position posture of the terminal device 200 corrected by the delay compensation unit 312, the display of the AR content represented by the content data at the display position on the display area of the display unit 217 corresponding to the corrected three-dimensional position of the object of interest.

### Operation of Terminal Device

A flow of operation (processing) of the terminal device 200 illustrated in FIG. 11 will be described with reference to the flowchart in FIG. 12. The processing illustrated in FIG. 12 is also repeatedly performed in synchronization with, for example, a frame rate at which the AR content is displayed on the display unit 217.

Note that, in steps S31 and S32 in FIG. 12, processing similar to the processing in steps S21 and S22 in FIG. 10 is performed, so that no description will be given below of the processing.

That is, in step S33, the relative position posture estimation unit 311 estimates the amount of change in relative position posture of the terminal device 200 from the acquisition time included in the object data of the object of interest on the basis of the camera image from the imaging unit 212.

In step S34, in a manner similar to step S23 in FIG. 10, the three-dimensional position represented by the three-dimensional position information included in the object data of the object of interest is associated with the position, on the camera image, of the object of interest appearing in the camera image.

In step S35, in a manner similar to step S24 in FIG. 10, the absolute position posture of the terminal device 200 is estimated on the basis of the correspondence between the three-dimensional position of the object of interest and the position, on the camera image, of the object of interest appearing in the camera image.

In step S36, the delay compensation unit 312 corrects the absolute position posture of the terminal device 200 and the three-dimensional position of the object of interest on the basis of the amount of change in relative position posture of the terminal device 200 estimated by the relative position posture estimation unit 311.

Then, in step S37, the display control unit 216 displays the AR content represented by the content data at the display position on the display area of the display unit 217 corresponding to the corrected three-dimensional position of the object of interest on the basis of the absolute position posture of the terminal device 200 corrected by the delay compensation unit 312.

According to the above-described configuration and processing, the AR display system can display, even in a case where the delay time from the acquisition of the sensor data to the display of the AR content is large, the AR content with the display position aligned with the object of interest.

Note that the delay compensation unit 312 may predict the future absolute position posture of the terminal device 200 using the past information held by the relative position posture estimation unit 311 or the object tracking unit 213 in consideration of the time required for rendering the AR content and the like. For example, the delay compensation unit 312 can predict the future absolute position posture of the terminal device 200 by estimating a motion state (such as uniform linear motion) of the terminal device 200 or the object of interest using the amount of past change in relative position posture of the terminal device 200 and the position (trajectory), on the past camera image, of the object of interest appearing in the camera image.

### 6. Configuration Example of Computer

The series of processing described above can be performed by hardware, or can be performed by software. In a case where the series of processing is performed by software, a program constituting the software is installed on a computer built into dedicated hardware or a general-purpose personal computer from a program recording medium.

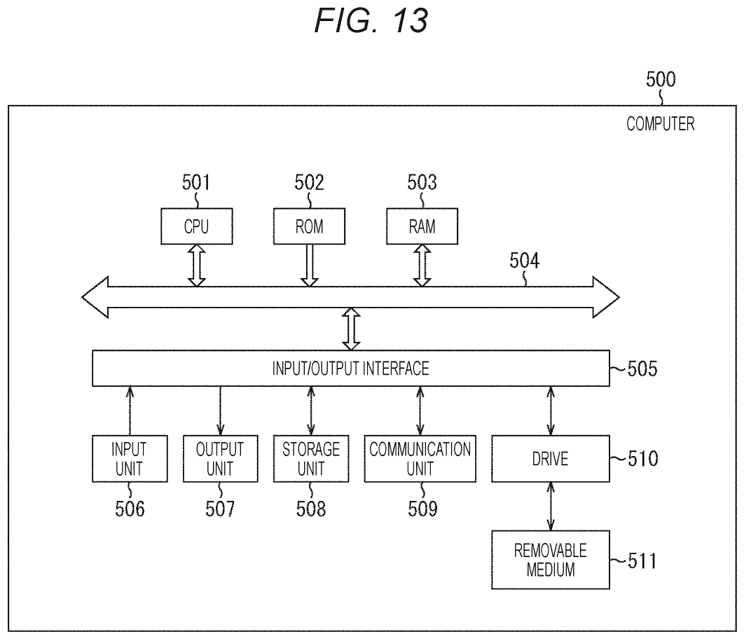

FIG. 13 is a block diagram illustrating a configuration example of the hardware of the computer that performs the above-described series of processing by means of the program.

The server 100 and the terminal device 200 to which the technology according to the present disclosure can be applied are each implemented by a computer 500 having the configuration illustrated in FIG. 13.

A CPU 501, a read only memory (ROM) 502, and a random access memory (RAM) 503 are mutually connected over a bus 504.

An input/output interface 505 is further connected to the bus 504. An input unit 506 including a keyboard, a mouse, and the like, and an output unit 507 including a display, a speaker, and the like are connected to the input/output interface 505. Furthermore, a storage unit 508 including a hard disk, a nonvolatile memory, or the like, a communication unit 509 including a network interface or the like, and a drive 510 that drives a removable medium 511 are connected to the input/output interface 505.

In the computer configured as described above, for example, the CPU 501 loads a program stored in the storage unit 508 into the RAM 503 via the input/output interface 505 and the bus 504 and executes the program to perform the above-described series of processing.

For example, the program executed by the CPU 501 is recorded in the removable medium 511, or provided via a wired or wireless transmission medium such as a local area network, the Internet, or digital broadcasting, and then installed in the storage unit 508.

Note that the program to be executed by the computer may be a program in which processing is performed in the time-series order described herein, or may be a program in which processing is performed in parallel or at necessary timing such as when a call is made, or the like.

The embodiment of the present disclosure is not limited to the above-described embodiments, and various modifications can be made without departing from the scope of the present disclosure.

Furthermore, the effects described herein are merely examples and are not restrictive, and other effects may be provided.

Moreover, the present disclosure may have the following configurations.
(1)

A terminal device including
a position estimation unit configured to estimate an absolute position posture of an own device on the basis of a correspondence between a three-dimensional position included in object data of an object of interest to which a user pays attention and a position, on a camera image of the user, of the object of interest appearing in the camera image.
(2)

The terminal device according to (1), in which
the position estimation unit estimates a three-dimensional position and a posture of the own device as the absolute position posture.
(3)

The terminal device according to (2), further including
an associating unit configured to associate the three-dimensional position of the object of interest with the position on the camera image of the object of interest.
(4)

The terminal device according to (3), in which
the associating unit associates the three-dimensional position of the object of interest with the position on the camera image of the object of interest on the basis of a feature of the object of interest included in the object data and the feature of the object of interest appearing in the camera image.
(5)

The terminal device according to (3), in which
the associating unit associates the three-dimensional position of the object of interest with the position on the camera image of the object of interest by recognizing, in the camera image, a sensor used to acquire the object data, the sensor being attached to the object of interest.
(6)

The terminal device according to any one of (1) to (5), further including
a delay compensation unit configured to correct the absolute position posture in accordance with an acquisition time at which the object data is acquired.
(7)

The terminal device according to (6), further including
a relative position posture estimation unit configured to estimate an amount of change in relative position posture of the own device from the acquisition time on the basis of the camera image, in which
the delay compensation unit corrects the absolute position posture on the basis of the amount of change in relative position posture that has been estimated.
(8)

The terminal device according to (6), in which
the delay compensation unit corrects the absolute position posture by further using a position, on the camera image, of the object of interest appearing in the camera image, the position being corrected in accordance with the acquisition time.
(9)

The terminal device according to any one of (1) to (8), further including
a display control unit configured to control display of content at a display position corresponding to the object of interest on a display area on the basis of the absolute position posture that has been estimated.
(10)

The terminal device according to (9), in which
the display control unit controls display of the content in the display area that transmits a real space including the object of interest.
(11)

The terminal device according to (10),
configured as AR glasses.
(12)

The terminal device according to (9), in which
the display control unit controls display of the content superimposed on the camera image including the object of interest displayed in the display area.
(13)

The terminal device according to (12), configured as a smartphone.
(14)

The terminal device according to any one of (9) to (13), further including
a reception unit configured to receive the object data of the object of interest distributed together with the content from a server, the server being configured to generate the content.
(15)

The terminal device according to any one of (9) to (14), in which
the object of interest includes a competitor, an animal, a machine, and equipment related to a sports competition, each joint of the competitor or the animal, and a part of the machine or the equipment, and
the content includes display information indicating a record of the sports competition, reproduction of a motion of the object of interest, and a trajectory of the object of interest.
(16)

A position posture estimation method including
by a terminal device,
estimating an absolute position posture of an own device on the basis of a correspondence between a three-dimensional position included in object data of an object of interest to which a user pays attention and a position, on a camera image of the user, of the object of interest appearing in the camera image.
(17)

A program for causing a computer to perform processing, the processing including
estimating an absolute position posture of a terminal device on the basis of a correspondence between a three-dimensional position included in object data of an object of interest to which a user pays attention and a position, on a camera image of the user, of the object of interest appearing in the camera image.

### REFERENCE SIGNS LIST

100 Server
111 Object data generation unit
112 Content data generation unit
113 Data distribution unit
200 Terminal device
211 Reception unit
212 Imaging unit
213 Object tracking unit
214 Associating unit
215 Absolute position posture estimation unit
216 Display control unit
217 Display unit
311 Relative position posture estimation unit
312 Delay compensation unit

1. A terminal device comprising
a position estimation unit configured to estimate an absolute position posture of an own device on a basis of a correspondence between a three-dimensional position included in object data of an object of interest to which a user pays attention and a position, on a camera image of the user, of the object of interest appearing in the camera image.

2. The terminal device according to claim 1, wherein
the position estimation unit estimates a three-dimensional position and a posture of the own device as the absolute position posture.

3. The terminal device according to claim 2, further comprising
an associating unit configured to associate the three-dimensional position of the object of interest with the position on the camera image of the object of interest.

4. The terminal device according to claim 3, wherein
the associating unit associates the three-dimensional position of the object of interest with the position on the camera image of the object of interest on a basis of a feature of the object of interest included in the object data and the feature of the object of interest appearing in the camera image.

5. The terminal device according to claim 3, wherein
the associating unit associates the three-dimensional position of the object of interest with the position on the camera image of the object of interest by recognizing, in the camera image, a sensor used to acquire the object data, the sensor being attached to the object of interest.

6. The terminal device according to claim 1, further comprising
a delay compensation unit configured to correct the absolute position posture in accordance with an acquisition time at which the object data is acquired.

7. The terminal device according to claim 6, further comprising
a relative position posture estimation unit configured to estimate an amount of change in relative position posture of the own device from the acquisition time on a basis of the camera image, wherein
the delay compensation unit corrects the absolute position posture on a basis of the amount of change in relative position posture that has been estimated.

8. The terminal device according to claim 6, wherein
the delay compensation unit corrects the absolute position posture by further using a position, on the camera image, of the object of interest appearing in the camera image, the position being corrected in accordance with the acquisition time.

9. The terminal device according to claim 1, further comprising
a display control unit configured to control display of content at a display position corresponding to the object of interest on a display area on a basis of the absolute position posture that has been estimated.

10. The terminal device according to claim 9, wherein
the display control unit controls display of the content in the display area that transmits a real space including the object of interest.

11. The terminal device according to claim 10,
configured as AR glasses.

12. The terminal device according to claim 9, wherein
the display control unit controls display of the content superimposed on the camera image including the object of interest displayed in the display area.

13. The terminal device according to claim 12,
configured as a smartphone.

14. The terminal device according to claim 9, further comprising
a reception unit configured to receive the object data of the object of interest distributed together with the content from a server, the server being configured to generate the content.

15. The terminal device according to claim 9, wherein
the object of interest includes a competitor, an animal, a machine, and equipment related to a sports competition, each joint of the competitor or the animal, and a part of the machine or the equipment, and
the content includes display information indicating a record of the sports competition, reproduction of a motion of the object of interest, and a trajectory of the object of interest.

16. A position posture estimation method comprising
by a terminal device,
estimating an absolute position posture of an own device on a basis of a correspondence between a three-dimensional position included in object data of an object of interest to which a user pays attention and a position, on a camera image of the user, of the object of interest appearing in the camera image.

17. A program for causing a computer to perform processing, the processing comprising
estimating an absolute position posture of a terminal device on a basis of a correspondence between a three-dimensional position included in object data of an object of interest to which a user pays attention and a position, on a camera image of the user, of the object of interest appearing in the camera image.
